(19) United States
(12) Patent Application Publication
(10) Pub. No.: US 2026/0299279 A1
(43) Pub. Date: Oct. 1, 2026

(54) OPTICAL SYSTEM

(71) Applicant: Asia Optical Co., Inc., Taichung (TW)

(72) Inventors: Yao Pei, ShenZhen City (CN); Fang-Li Ma, ShenZhen City (CN); Yue-Ye Chen, ShenZhen City (CN); Hua-Tang Liu, Taichung (TW)

(21) Appl. No.: 19/530,614

(22) Filed: Feb. 5, 2026

(30) Foreign Application Priority Data
Mar. 19, 2025 (CN) 202510330227.0

(51) Int. Cl. G02B 23/02; G02B 3/00; G02B 7/02; G02B 25/00; G02B 27/64

(52) U.S. Cl. CPC G02B 23/02; G02B 7/025; G02B 25/001; G02B 27/646; G02B 2003/0093

(57) ABSTRACT

An optical system includes an object lens group, an erector lens group, and an eyepiece group, all of which are arranged in order from an object side to an image side along an optical axis. The object lens group includes a first lens, a second lens, a third lens, a fourth lens, and an optical element. The first lens, the second lens, the third lens, and the fourth lens are arranged in order from the object side to the image side along the optical axis. The optical element includes a light guide surface and the light guide surface is rotated, moved, or tilted relative to the optical axis. The eyepiece group includes a fifth lens, a sixth lens, a seventh lens, and an eighth lens. The fifth, sixth, seventh, and eighth lenses are arranged in order from the object side to the image side along the optical axis.

### BACKGROUND OF THE INVENTION

### Field of the Invention

The invention relates to an optical system.

### Description of the Related Art

Modern telescopes offer higher and higher magnification, allowing them to see farther. However, as magnification increases, the field of vision is more easily shaken by hand tremble, leading to a poor user experience and easily to degrade image quality.

### BRIEF SUMMARY OF THE INVENTION

The invention provides an optical system to solve the above problems. The optical system uses optical element to achieve optical compensation and improve image quality. Therefore, the telescope needs a new structure in order to meet the requirements of image stabilization, telephoto capability, and image quality.

The optical system in accordance with an exemplary embodiment of the invention includes an object lens group, an erector lens group, and an eyepiece group. The object lens group, the erector lens group, and the eyepiece group are arranged in order from an object side to an image side along an optical axis. The object lens group includes a first lens, a second lens, a third lens, a fourth lens, and an optical element. The optical element is disposed between the second lens and the third lens or the optical element is disposed between the third lens and the fourth lens. The optical element includes a light guide surface and the light guide surface is rotated, moved, or tilted relative to the optical axis. The first lens is with refractive power and includes a convex surface facing the object side. The second lens is with refractive power. The third lens is with refractive power. The fourth lens is with refractive power. The first lens, the second lens, the third lens, and the fourth lens are arranged in order from the object side to the image side along the optical axis. The eyepiece group includes a fifth lens, a sixth lens, a seventh lens, and an eighth lens. The fifth lens is with refractive power and includes a concave surface facing the object side. The sixth lens is with refractive power and includes a convex surface facing the image side. The seventh lens is with positive refractive power and includes a convex surface facing the object side. The eighth lens is with positive refractive power and includes a convex surface facing the object side. The fifth lens, the sixth lens, the seventh lens, and the eighth lens are arranged in order from the object side to the image side along the optical axis.

In another exemplary embodiment, the first lens is a biconvex lens and further includes another convex surface facing the image side; the second lens is a meniscus lens with negative refractive power and includes a concave surface facing the object side and a convex surface facing the image side; the third lens is a meniscus lens with positive refractive power and includes a convex surface facing the object side and a concave surface facing the image side; the fourth lens is a meniscus lens with negative refractive power and includes a convex surface facing the object side and a concave surface facing the image side; the fifth lens is a biconcave lens with negative refractive power and further includes another concave surface facing the image side; the sixth lens is a biconvex lens and further includes another convex surface facing the object side; the seventh lens is a meniscus lens and further includes a concave surface facing the image side; and the eighth lens is a meniscus lens and further includes a concave surface facing the image side.

The optical system in accordance with another exemplary embodiment of the invention includes an object lens group, an erector lens group, and an eyepiece group. The object lens group, the erector lens group, and the eyepiece group are arranged in order from an object side to an image side along an optical axis. The object lens group includes a first lens, a second lens, a third lens, a fourth lens, and an optical element. The optical element is disposed between the second lens and the third lens or the optical element is disposed between the third lens and the fourth lens. The first lens is with refractive power and includes a convex surface facing the object side. The second lens is with refractive power. The third lens is with refractive power. The fourth lens is with refractive power. The refractive power of the fourth lens is opposite to the refractive power of the third lens. The first lens, the second lens, the third lens, and the fourth lens are arranged in order from the object side to the image side along the optical axis. The eyepiece group includes a fifth lens, a sixth lens, a seventh lens, and an eighth lens. The fifth lens is with refractive power and includes a concave surface facing the object side. The sixth lens is with refractive power and includes a convex surface facing the image side. The seventh lens is a biconvex lens with positive refractive power and includes a convex surface facing the object side and another convex surface facing the image side. The eighth lens is a biconvex lens with positive refractive power and includes a convex surface facing the object side and another convex surface facing the image side. The fifth lens, the sixth lens, the seventh lens, and the eighth lens are arranged in order from the object side to the image side along the optical axis.

In another exemplary embodiment, the optical element includes a light guide surface and the light guide surface is rotated, moved, or tilted relative to the optical axis.

In yet another exemplary embodiment, the third lens is with negative refractive power and includes a plane surface facing the object side or the image side; the fourth lens is with positive refractive power and includes a plane surface facing the object side or the image side; and when the third lens includes a concave surface facing the object side, the fourth lens includes a convex surface facing the image side, or when the third lens includes a concave surface facing the image side, the fourth lens includes a convex surface facing the object side.

In another exemplary embodiment, a combination of the first lens and the second lens is with positive refractive power and a combination of the fifth lens and the sixth lens is with positive refractive power; the first lens is a biconvex lens with positive refractive power and further includes another convex surface facing the image side; the second lens is with negative refractive power and includes a concave surface facing the object side; the fifth lens is a biconcave lens with negative refractive power and further includes another concave surface facing the image side; and the sixth lens is a biconvex lens with positive refractive power and further includes another convex surface facing the object side.

In yet another exemplary embodiment, the second lens is a biconcave lens and further includes another concave surface facing the image side.

In another exemplary embodiment, the second lens is a meniscus lens and further includes a convex surface facing the image side.

In yet another exemplary embodiment, the optical system satisfies at least one of the following conditions: 1.7≤ODOBJmax/ODEYEmin≤2.1; 0.7≤|f3/f4|≤1.8; (f3/f4)<(f7/f8); fcomb1≥250 mm; 0 degree≤TΘ≤2 degree; 0.5 degree≤LΘ≤0.7 degree; wherein ODOBJmax is a maximum effective optical diameter of the object lens group, ODEYEmin is a minimum effective optical diameter of the eyepiece group, f3 is an effective focal length of the third lens, f4 is an effective focal length of the fourth lens, f7 is an effective focal length of the seventh lens, f8 is an effective focal length of the eighth lens, fcomb1 is an effective focal length of a combination of lenses which are between the object side and the optical element, TΘ is an inclination angle between the light guide surface of the optical element and the vertical direction of the optical axis, and LΘ is a maximum optical compensation angle of the optical system.

In another exemplary embodiment, the optical element is a liquid prism; the liquid prism includes an object side surface facing the object side and an image side surface facing the image side, and both of the object side surface and image side surface are plane surfaces; and when the object side surface is perpendicular to the optical axis, the image side surface is tilted at an inclination angle to the vertical direction of the optical axis to achieve optical image stabilization, or when the image side surface is perpendicular to the optical axis, the object side surface is tilted at an inclination angle to the vertical direction of the optical axis to achieve optical image 115 stabilization.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout diagram of an optical system in accordance with a first embodiment of the invention, wherein the image side surface of the optical element is not tilted;

FIG. 2 is a lens layout diagram of the optical system in accordance with the first embodiment of the invention, wherein the image side surface of the optical element is tilted;

FIG. 3 depicts a longitudinal aberration diagram of the optical system without shake in accordance with the first embodiment of the invention;

FIG. 4 is a field curvature and a distortion diagrams of the optical system without shake in accordance with the first embodiment of the invention;

FIG. 5 is a modulation transfer function diagram of the optical system without shake in accordance with the first embodiment of the invention;

FIG. 6 is a field curvature and a distortion diagrams of the optical system under maximum shake compensation in accordance with the first embodiment of the invention;

FIG. 7 is a modulation transfer function diagram of the optical system under maximum shake compensation in accordance with the first embodiment of the invention;

FIG. 8 is a lens layout diagram of an optical system in accordance with a second embodiment of the invention, wherein the image side surface of the optical element is not tilted;

FIG. 9 depicts a longitudinal aberration diagram of the optical system without shake in accordance with the second embodiment of the invention;

FIG. 10 is a field curvature and a distortion diagrams of the optical system without shake in accordance with the second embodiment of the invention;

FIG. 11 is a modulation transfer function diagram of the optical system without shake in accordance with the second embodiment of the invention;

FIG. 12 is a field curvature and a distortion diagrams of the optical system under maximum shake compensation in accordance with the second embodiment of the invention; and

FIG. 13 is a modulation transfer function diagram of the optical system under maximum shake compensation in accordance with the second embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides an optical system including an object lens group, an erector lens group, and an eyepiece group. The object lens group, the erector lens group, and the eyepiece group are arranged in order from an object side to an image side along an optical axis. The object lens group includes a first lens, a second lens, a third lens, a fourth lens, and an optical element. The optical element is disposed between the second lens and the third lens or the optical element is disposed between the third lens and the fourth lens. The optical element includes a light guide surface and the light guide surface is rotated, moved, or tilted relative to the optical axis. The first lens is with positive or negative refractive power and includes a convex surface facing the object side, and a convex surface, a concave surface, or a plane surface facing the image side. The second lens is with positive or negative refractive power, and the optical surface shape can be biconvex, biconcave, plano-convex, plano-concave, or meniscus (concave convex or convex concave). The third lens is with positive or negative refractive power, and the optical surface shape can be biconvex, biconcave, plano-convex, plano-concave, or meniscus (concave convex or convex concave). The fourth lens is with positive or negative refractive power, and the optical surface shape can be biconvex, biconcave, plano-convex, plano-concave, or meniscus (concave convex or convex concave). The first lens, the second lens, the third lens, and the fourth lens are arranged in order from the object side to the image side along the optical axis. The eyepiece group includes a fifth lens, a sixth lens, a seventh lens, and an eighth lens. The fifth lens is with positive or negative refractive power and includes a concave surface facing the object side, and a convex surface, a concave surface, or a plane surface facing the image side. The sixth lens is with positive or negative refractive power and includes a convex surface facing the image side, and a convex surface, a concave surface, or a plane surface facing the object side. The seventh lens is with positive refractive power and includes a convex surface facing the object side, and a convex surface, a concave surface, or a plane surface facing the image side. The eighth lens is with positive refractive power and includes a convex surface facing the object side, and a convex surface, a concave surface, or a plane surface facing the image side. The fifth lens, the sixth lens, the seventh lens, and the eighth lens are arranged in order from the object side to the image side along the optical axis. The basic function of the optical system of the present invention can be achieved when the optical system of the present invention satisfies the above features, and does not require other additional features or conditions.

The present invention provides another optical system including an object lens group, an erector lens group, and an eyepiece group. The object lens group, the erector lens group, and the eyepiece group are arranged in order from an object side to an image side along an optical axis. The object lens group includes a first lens, a second lens, a third lens, a fourth lens, and an optical element. The optical element is disposed between the second lens and the third lens or the optical element is disposed between the third lens and the fourth lens. The first lens is with positive or negative refractive power and includes a convex surface facing the object side, and a convex surface, a concave surface, or a plane surface facing the image side. The second lens is with positive or negative refractive power, and the optical surface shape can be biconvex, biconcave, plano-convex, plano-concave, or meniscus (concave convex or convex concave). The third lens is with positive or negative refractive power, and the optical surface shape can be biconvex, biconcave, plano-convex, plano-concave, or meniscus (concave convex or convex concave). The fourth lens is with positive or negative refractive power, and the optical surface shape can be biconvex, biconcave, plano-convex, plano-concave, or meniscus (concave convex or convex concave). The refractive power of the fourth lens is opposite to the refractive power of the third lens. The first lens, the second lens, the third lens, and the fourth lens are arranged in order from the object side to the image side along the optical axis. The eyepiece group includes a fifth lens, a sixth lens, a seventh lens, and an eighth lens. The fifth lens is with positive or negative refractive power and includes a concave surface facing the object side, and a convex surface, a concave surface, or a plane surface facing the image side. The sixth lens is with positive or negative refractive power and includes a convex surface facing the image side, and a convex surface, a concave surface, or a plane surface facing the object side. The seventh lens is a biconvex lens with positive refractive power and includes a convex surface facing the object side and another convex surface facing the image side. The eighth lens is a biconvex lens with positive refractive power and includes a convex surface facing the object side and another convex surface facing the image side. The fifth lens, the sixth lens, the seventh lens, and the eighth lens are arranged in order from the object side to the image side along the optical axis. The basic function of the optical system of the present invention can be achieved when the optical system of the present invention satisfies the above features, and does not require other additional features or conditions.

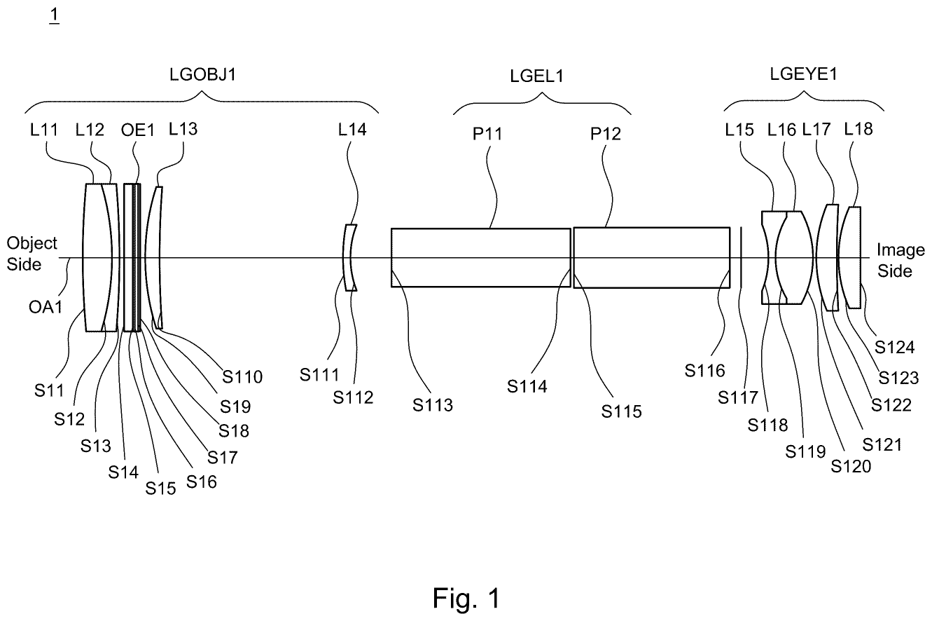

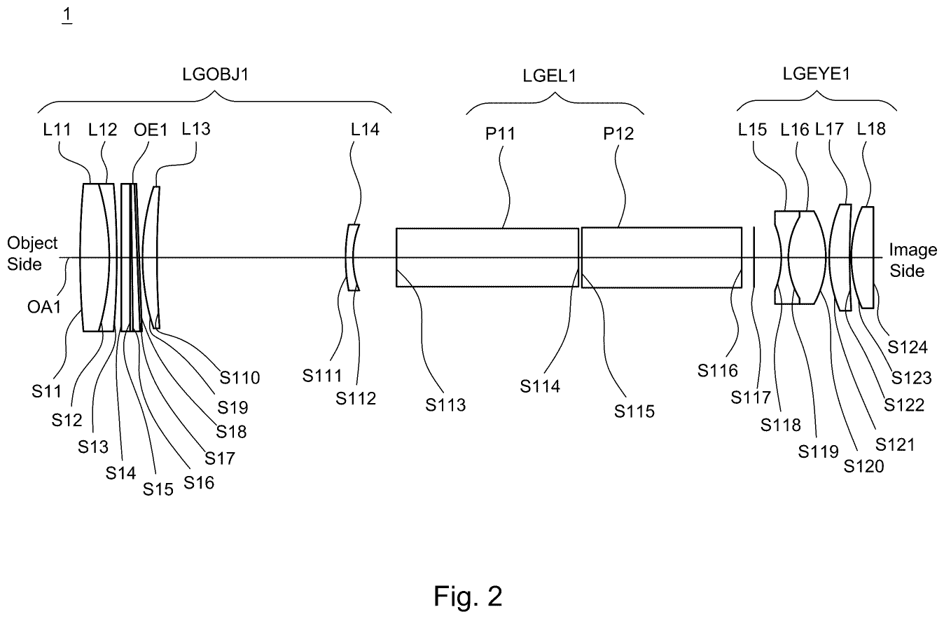

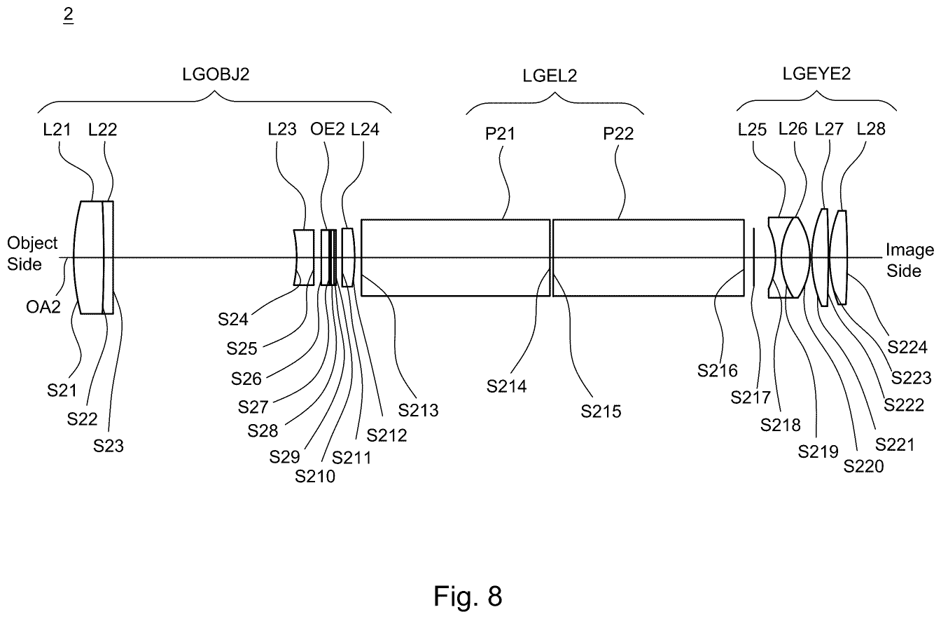

Referring to Table 1, Table 3, and Table 5, wherein Table 1, Table 3, and Table 5 show optical specification in accordance with a first, a second, and a third embodiments of the invention, respectively. FIG. 1 is a lens layout diagram of an optical system in accordance with a first embodiment of the invention, wherein the image side surface of the optical element is not tilted. FIG. 2 is the lens layout diagram of the optical system in accordance with the first embodiment of the invention, wherein the image side surface of the optical element is tilted. FIG. 8 is a lens layout diagram of an optical system in accordance with a second embodiment of the invention, wherein the image side surface of the optical element is not tilted. The figure depicts the lens layout diagram of an optical system in accordance with a third embodiment of the invention approximating to the lens layout diagram of the optical system in accordance with the second embodiment of the invention, therefore its figure is omitted. However, in the following content concerning the third embodiment, the element symbols of the third embodiment will continue to be used for ease of explanation. All lenses in the first, second, and third embodiments are, but not limited to, spherical surface and made of glass material.

The optical lens groups LGOBJ1, LGOBJ2 are with positive refractive power and include the first lenses L11, L21, the second lenses L12, L22, the optical elements OE1, OE2, the third lens L13, L14, and the fourth lenses L14, L24, respectively. The erector lens groups LGEL1, LGEL2 include the first prisms P11, P21 and the second prisms P12, P22, respectively. The eyepiece groups LGEYE1, LGEYE2 include the fifth lenses L15, L25, the sixth lenses L16, L26, the seventh 250 lenses L17, L27, and the eighth lenses L18, L28, respectively.

The first lenses L11, L21, L31 are biconvex lenses with positive refractive power, wherein the object side surfaces S11, S21, S31 are convex surfaces and the image side surfaces S12, S22, S32 are convex surfaces. The second lenses L12, L22, L32 are with negative refractive power, wherein the object side surfaces S12, S22, 255 S32 are concave surfaces. The first lenses L11, L21, L31 and the second lenses L12, L22, L32 are cemented, respectively, or there is no air gap between the first lenses L11, L21, L31 and the second lenses L12, L22, L32, respectively. The combinations of the first lenses L11, L21, L31 and the second lenses L12, L22, L32 are with positive refractive power, respectively. The third lenses L13, L23, L33 are with refractive power. The fourth lenses L14, L24, L34 are with refractive power. The fifth lenses L15, L25, L35 are biconcave lenses with negative refractive power, wherein the object side surfaces S118, S218, S318 are concave surfaces and the image side surfaces S119, S219, S319 are concave surfaces. The sixth lenses L16, L26, L36 are biconvex lenses with positive refractive power, wherein the object side surfaces S119, S219, S319 are convex surfaces and the image side surfaces S120, S220, S320 are convex surfaces. The fifth lenses L15, L25, L35 and the sixth lenses L16, L26, L36 are cemented, respectively, or there is no air gap between the fifth lenses L15, L25, L35 and the sixth lenses L16, L26, L36, respectively. The combinations of the fifth lenses L15, L25, L35 and the sixth lenses L16, L26, L36 are with positive refractive power, respectively. The seventh lenses L17, L27, L37 are with positive refractive power, wherein the object side surfaces S121, S221, S321 are convex surfaces. The eighth lenses L18, L28, L38 are with positive refractive power, wherein the object side surfaces S123, S223, S323 are convex surfaces.

In addition, the optical systems 1, 2, 3 satisfy at least one of the following conditions:

$$1.7 \leq ODOBJ max / ODEYE min \leq 2.1 ; \qquad ( 1 )$$

$$0.7 \leq \vert f 3 / f 4 \vert \leq 1.8 ; \qquad ( 2 )$$

$$( f 3 / f 4 ) < ( f 7 / f 8 ) ; \qquad ( 3 )$$

$$fcomb 1 \geq 250 mm ; \qquad ( 4 )$$

$$0 degree \leq T Θ \leq 2 degree or 0.5 degree \leq L Θ \leq 0.7 degree ; \qquad ( 5 )$$

wherein ODOBJmax is a maximum effective optical diameter of the object lens groups LGOBJ1, LGOBJ2, LGOBJ3 for the first to third embodiments, ODEYEmin is a minimum effective optical diameter of the eyepiece groups LGEYE1, LGEYE2, LGEYE3 for the first to third embodiments, f3 is an effective focal length of the third lenses L13, L23, L33 for the first to third embodiments, f4 is an effective focal length of the fourth lenses L14, L24, L34 for the first to third embodiments, f7 is an effective focal length of the seventh lenses L17, L27, L37 for the first to third embodiments, f8 is an effective focal length of the eighth lenses L18, L28, L38 for the first to third embodiments, fcomb1 is an effective focal length of the combination of lenses which are between the object side and the optical elements OE1, OE2, OE3 for the first to third embodiments, TΘ is an inclination angle between the light guide surface of the optical elements OE1, OE2, OE3 and the vertical direction of the optical axes OA1, OA2, OA3 for the first to third embodiments, and LΘ is a maximum optical compensation angle of the optical systems 1, 2, 3 for the first to third embodiments. With the optical systems 1, 2, 3 satisfying at least one of the above conditions (1)-(5), the aberration can be effectively corrected, the chromatic aberration can be effectively corrected, and anti-shake effect can be effectively improved.

A detailed description of an optical system in accordance with a first embodiment of the invention is as follows. Referring to FIG. 1 and FIG. 2, the optical system 1 includes an object lens group LGOBG1, an erector lens group LGEL1, and an eyepiece group LGEYE1, all of which are arranged in order from an object side to an image side along an optical axis OA1. The object lens group LGOBJ1 includes a first lens L11, a second lens L12, an optical element OE1, a third lens L13, and a 305 fourth lens L14, all of which are arranged in order from the object side to the image side along the optical axis OA1. The erector lens group LGEL1 includes a first prism P11 and a second prism P12, all of which are arranged in order from the object side to the image side along the optical axis OA1. The eyepiece group LGEYE1 includes a fifth lens L15, a sixth lens L16, a seventh lens L17, and an eighth lens L18, 310 all of which are arranged in order from the object side to the image side along the optical axis OA1. The first lens L11, the second lens L12, the optical element OE1, the third lens L13, the fourth lens L14, the first prism P11, the second prism P12, the fifth lens L15, the sixth lens L16, the seventh lens L17, and the eighth lens L18 are arranged in order from the object side to the image side along the optical axis OA1. The optical element OE1 of the first embodiment is a liquid prism with an optical image stabilization function, wherein there are two types of liquid with different refractive indices and are disposed between the object side surface S15 of the first liquid and the image side surface S17 of the second liquid. Both of the object side surface S14 and image side surface S18 of the optical element OE1 (liquid prism) are plane surfaces. When the optical image stabilization function is not enabled (as shown in FIG. 1), the image side surface (light guide surface) S18 is perpendicular to the optical axis OA1. When the optical image stabilization function is enabled (as shown in FIG. 2), the image side surface (light guide surface) S18 is not perpendicular to the optical axis OA1 but is tilted relative to the optical axis OA1, so that a tilt angle 325 is formed between the image side surface S18 and the direction perpendicular to the optical axis OA1. The tilt angle is 0-2 degrees, for example but not limited to 1.51 degrees. The maximum optical compensation angle is 0.5-0.7 degrees, for example but not limited to 0.6 degrees. In operation, a light from the object side first enters the object lens group LGOBJ1, then the erector lens group LGEL1 and is imaged an upright image on focal plane S117, then the eyepiece group LGEYE1, and is finally viewed by the human eyes.

According to the foregoing, wherein: the second lens L12 is a meniscus lens, wherein the image side surface S13 is a convex surface; the third lens L13 is a meniscus lens with positive refractive power, wherein the object side surface S19 is a convex surface, the image side surface S110 is a concave surface; the fourth lens L14 is a meniscus lens with negative refractive power, wherein the object side surface S111 is a convex surface, the image side surface S112 is a concave surface; the seventh lens L17 is a meniscus lens, wherein the image side surface S122 is a concave surface; and the eighth lens L18 is a meniscus lens, wherein the image side surface S124 is a concave surface. With the above design of the lenses, optical element, and at least one of the conditions (1)-(5) is satisfied, the optical system 1 can have an effective corrected aberration, an effective corrected chromatic aberration, and an effective improved anti-shake effect.

Table 1 shows the optical specification of the optical system 1 in FIG. 1.

TABLE 1

| | | | | | Effective | Effective | |
|---|---|---|---|---|---|---|---|
| | Radius of | | | | Focal | Optical | |
| Surface | Curvature | Thickness | | | Length | Diameter | |
| Number | (mm) | (mm) | Nd | Vd | (mm) | (mm) | Remark |
| S11 | 200.0 | 6.50 | 1.5928 | 68.3420 | 77.01 | 30 | L11 |
| S12 | −58.4391 | 1.50 | 1.8061 | 33.2869 | −110.57 | 30 | L12 |
| S13 | −171.648 | 1.00 | | | | 30 | |
| S14 | ∞ | 2.20 | 1.5168 | 64.1987 | | 30 | OE1 |
| S15 | ∞ | 0.05 | 1.41 | 49.9 | | 30 | |
| S16 | ∞ | 0.85 | 1.4498 | 55.5096 | | 30 | |
| S17 | ∞ | 0.50 | 1.5168 | 64.1987 | | 30 | |
| S18 | ∞ | 1.00 | | | | 30 | |
| S19 | 48.52 | 3.00 | 1.6180 | 63.3927 | 108.70 | 30 | L13 |
| S110 | 170.58 | 40.39 | | | | 29.75 | |
| S111 | 43.14 | 1.60 | 1.5688 | 56.0413 | −63.31 | 14.13 | L14 |
| S112 | 19.36 | 8.94 | | | | 13.37 | |
| S113 | ∞ | 39.06 | 1.5688 | 56.06 | | 12.33 | P11 |
| S114 | ∞ | 0.8 | | | | 11.20 | |
| S115 | ∞ | 34.06 | 1.5688 | 56.06 | | 11.20 | P12 |
| S116 | ∞ | 2.59 | | | | 12.83 | |
| S117 | ∞ | 6.03 | | | | 13.02 | |
| S118 | −18.24 | 1.50 | 1.9228 | 20.8799 | −9.36 | 14.42 | L15 |
| S119 | 17.04 | 8.50 | 1.7725 | 49.5990 | 12.37 | 17.63 | L16 |
| S120 | −17.04 | 0.30 | | | | 19.98 | |
| S121 | 26.34 | 4.69 | 1.7291 | 54.6847 | 38.08 | 22.64 | L17 |
| S122 | 474.20 | 0.30 | | | | 22.26 | |
| S123 | 26.34 | 4.69 | 1.7291 | 54.6847 | 38.08 | 21.61 | L18 |
| S124 | 474.20 | 17.83 | | | | 20.32 | |

Table 2 shows the parameters and condition values for conditions (1)-(5) in accordance with the optical system 1 of the first embodiment. It can be seen from Table 2 that the optical system 1 of the first embodiment satisfies the conditions (1)-(5).

TABLE 2

| | | | | | | | |
|---|---|---|---|---|---|---|---|
| ODOBJmax | 30 | mm | ODEYEmin | 14.42 | mm | fcomb1 | 250.0 mm |
| TΘ | 1.51 | degrees | LΘ | 0.6 | degrees | | |

| | | | |
|---|---|---|---|
| ODOBJmax/ODEYEmin | 2.08 | \|f3/f4\| | 1.72 |
| f7/f8 | 1 | f3/f4 | −1.72 |

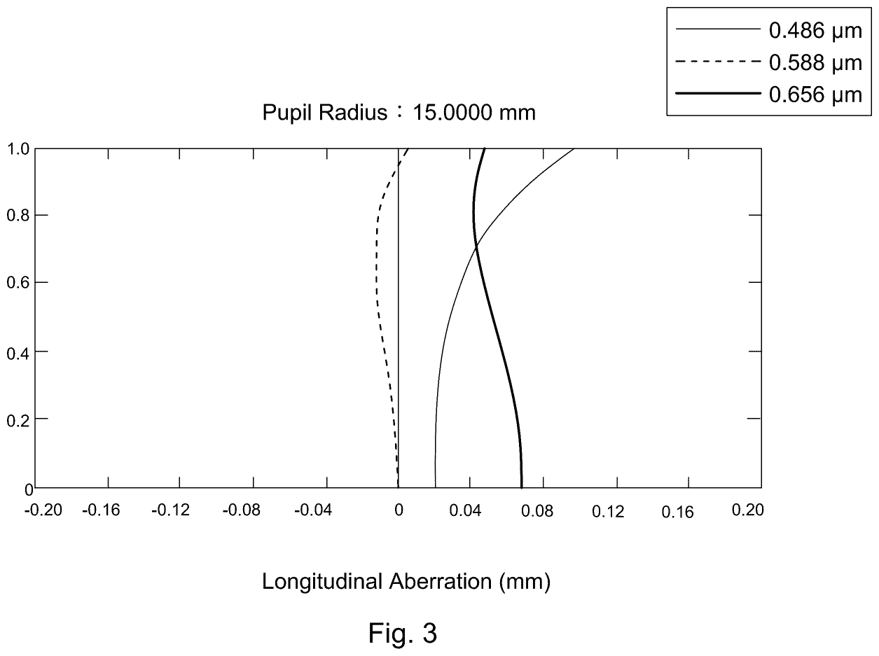

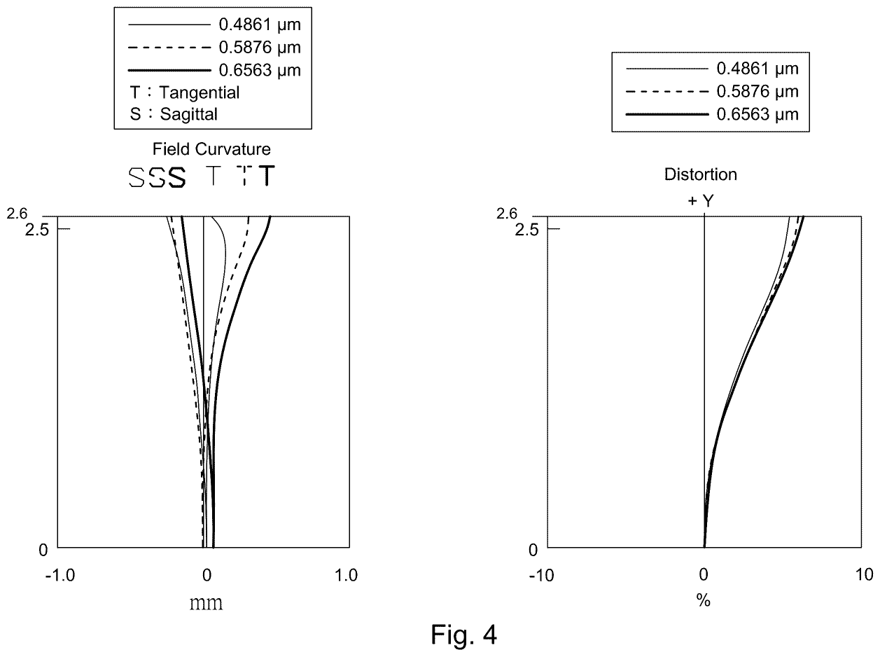

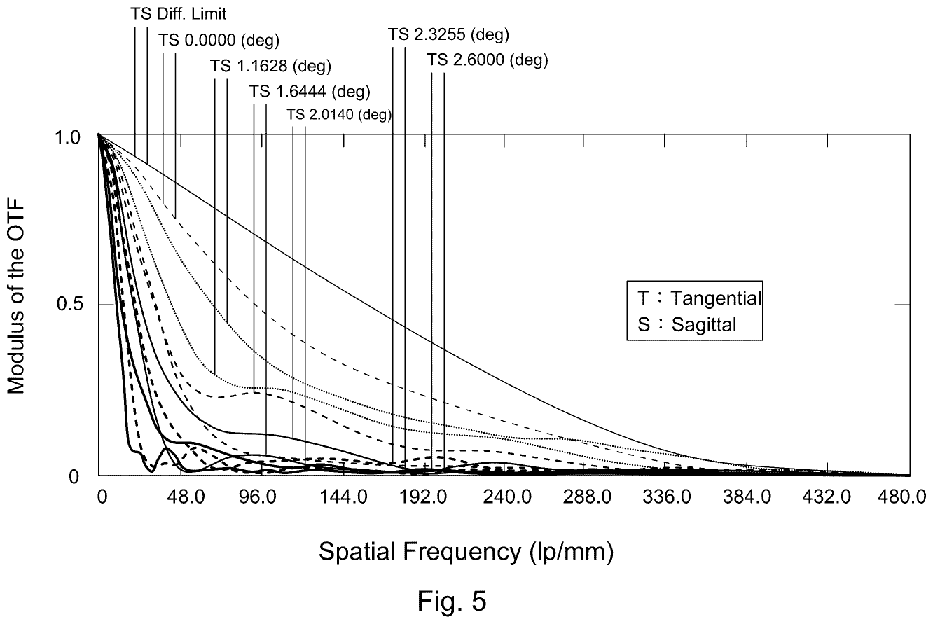

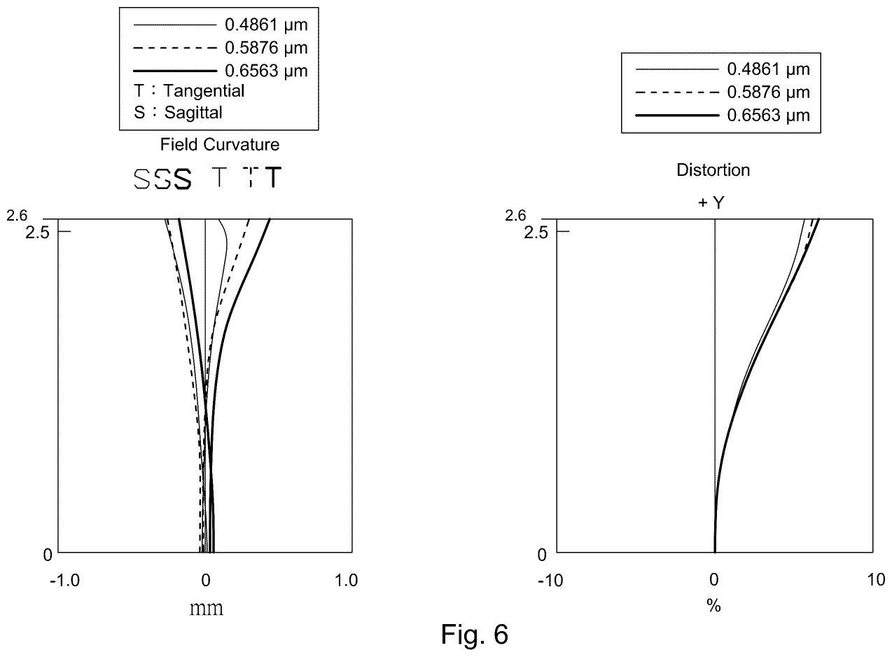

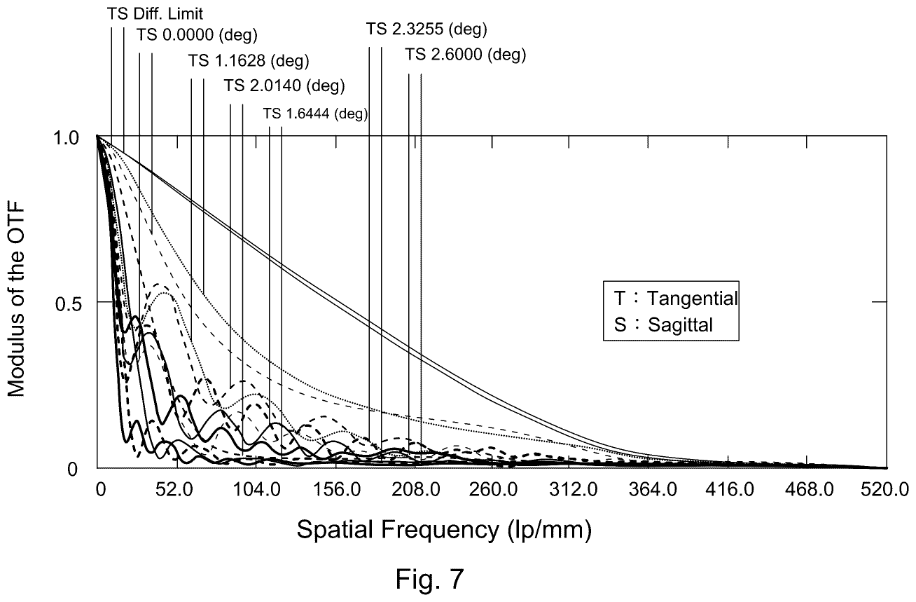

In addition, the optical system 1 of the first embodiment can meet the requirements of optical performance as seen in FIGS. 3-7. It can be seen from FIG. 3 that the longitudinal aberration in the optical system 1 of the first embodiment without shake ranges from −0.02 mm to 0.10 mm. It can be seen from FIG. 4 that the field 355 curvature of tangential direction and sagittal direction and distortion in the optical system 1 of the first embodiment without shake range from −0.3 mm to 0.5 mm and 0% to 6.5%, respectively. It can be seen from FIG. 5 that the modulation transfer function of tangential direction and sagittal direction in the optical system 1 of the first embodiment without shake ranges from 0.0 to 1.0. It can be seen from FIG. 6 that the field curvature of tangential direction and sagittal direction and distortion in the optical system 1 of the first embodiment under maximum shake compensation range from −0.3 mm to 0.5 mm and 0% to 7.0%, respectively. It can be seen from FIG. 7 that the modulation transfer function of tangential direction and sagittal direction in the optical system 1 of the first embodiment under maximum shake 365 compensation ranges from 0.0 to 1.0. It is obvious that the longitudinal aberration, the field curvature, and the distortion of the optical system 1 of the first embodiment can be corrected effectively and the image resolution can meet the requirements. Therefore, the optical system 1 of the first embodiment is capable of good optical performance.

A detailed description of an optical system in accordance with a second embodiment of the invention is as follows. Referring to FIG. 8, the optical system 2 includes an object lens group LGOBG2, an erector lens group LGEL2, and an eyepiece group LGEYE2, all of which are arranged in order from an object side to an image side along an optical axis OA2. The object lens group LGOBJ2 includes a 375 first lens L21, a second lens L22, a third lens L23, an optical element OE2, and a fourth lens L24, all of which are arranged in order from the object side to the image side along the optical axis OA2. The erector lens group LGEL2 includes a first prism P21 and a second prism P22, all of which are arranged in order from the object side to the image side along the optical axis OA2. The eyepiece group LGEYE2 includes a fifth lens L25, a sixth lens L26, a seventh lens L27, and an eighth lens L28, all of which are arranged in order from the object side to the image side along the optical axis OA2. The first lens L21, the second lens L22, the third lens L23, the optical element OE2, the fourth lens L24, the first prism P21, the second prism P22, the fifth lens L25, the sixth lens L26, the seventh lens L27, and the eighth lens L28 are arranged in order from the object side to the image side along the optical axis OA2. The optical element OE2 of the second embodiment is a liquid prism with an optical image stabilization function, wherein there are two types of liquid with different refractive indices and are disposed between the object side surface S27 of the first liquid and the image side surface S29 of the second liquid. Both of the object side surface S26 and image side surface S210 of the optical element OE2 (liquid prism) are plane surfaces. When the optical image stabilization function is not enabled (as shown in FIG. 8), the image side surface (light guide surface) S210 is perpendicular to the optical axis OA2. When the optical image stabilization function is enabled (not shown), the image side surface (light guide surface) S210 is not perpendicular to the optical axis OA2 but is tilted relative to the optical axis OA2, so that a tilt angle is formed between the image side surface S210 and the direction perpendicular to the optical axis OA2. The tilt angle is 0-2 degrees, for example but not limited to 1.51 degrees. The maximum optical compensation angle is 0.5-0.7 degrees, for example but not limited to 0.6 degrees. In operation, a light from the object side first enters the object lens group LGOBJ2, then the erector lens group LGEL2 and is imaged an upright image on focal plane S217, then the eyepiece group LGEYE2, and is finally viewed by the human eyes.

According to the foregoing, wherein: the second lens L22 is a biconcave lens, wherein the image side surface S23 is a concave surface; the third lens L23 is a plano-concave lens with negative refractive power, wherein the object side surface S24 is a concave surface and the image side surface S25 is a plane surface; the fourth lens L24 is a plano-convex lens with positive refractive power, wherein the object side surface S211 is a plane surface and the image side surface S212 is a convex surface; the seventh lens L27 is a biconvex lens, wherein the image side surface S222 is a convex surface; and the eighth lens L28 is a biconvex lens, wherein the image side surface S224 is a convex surface. With the above design of the lenses, optical element, and at least one of the conditions (1)-(5) is satisfied, the optical system 2 can have an effective corrected aberration, an effective corrected chromatic aberration, and an effective improved anti-shake effect.

Table 3 shows the optical specification of the optical system 2 in FIG. 8.

TABLE 3

| | | | | | Effective | Effective | |
|---|---|---|---|---|---|---|---|
| | Radius of | | | | Focal | Optical | |
| Surface | Curvature | Thickness | | | Length | Diameter | |
| Number | (mm) | (mm) | Nd | Vd | (mm) | (mm) | Remark |
| S21 | 59.7338 | 8.0 | 1.6204 | 60.339 | 94.32 | 30.00 | L21 |
| S22 | −2724.67 | 2.5 | 1.9229 | 18.896 | −599.32 | 29.17 | L22 |
| S23 | 694.26 | 50.0 | | | | 14.71 | |
| S24 | −40.64 | 4.18 | 1.7283 | 28.319 | −55.80 | 14.86 | L23 |
| S25 | ∞ | 2.5 | | | | 15.10 | |
| S26 | ∞ | 2.2 | 1.5168 | 64.199 | | 15.10 | OE2 |
| S27 | ∞ | 0.05 | 1.41 | 49.9 | | 15.25 | |
| S28 | ∞ | 0.85 | 1.4498 | 55.51 | | 15.26 | |
| S29 | ∞ | 0.5 | 1.5168 | 64.199 | | 15.32 | |
| S210 | ∞ | 2.0 | | | | 15.36 | |
| S211 | ∞ | 3.02 | 1.8348 | 42.725 | 75.10 | 15.59 | L24 |
| S212 | −62.70 | 2.0 | | | | 15.76 | |
| S213 | ∞ | 51.0 | 1.5688 | 56.06 | | 20.20 | P21 |
| S214 | ∞ | 0.8 | — | — | | 15.20 | |
| S215 | ∞ | 51.82 | 1.5688 | 56.06 | | 15.20 | P22 |
| S216 | ∞ | 2.5855 | | | | 20.00 | |
| S217 | ∞ | 6.0252 | | | | 15.53 | |
| S218 | −20.1932 | 1.5 | 1.946 | 17.942 | −10.00 | 16.82 | L25 |
| S219 | 18.4542 | 7.8070 | 1.755 | 52.322 | 13.44 | 20.72 | L26 |
| S220 | −18.4542 | 0.3 | | | | 21.78 | |
| S221 | 33.6405 | 4.6478 | 1.8348 | 42.725 | 34.60 | 26.24 | L27 |
| S222 | −191.4304 | 0.3 | | | | 26.14 | |
| S223 | 33.6405 | 4.6478 | 1.8348 | 42.725 | 34.60 | 25.38 | L28 |
| S224 | −191.4304 | 17.08 | | | | 24.51 | |

Table 4 shows the parameters and condition values for conditions (1)-(5) in accordance with the optical system 2 of the second embodiment. It can be seen from Table 4 that the optical system 2 of the second embodiment satisfies the conditions (1)-(5).

TABLE 4

| | | | | | | | |
|---|---|---|---|---|---|---|---|
| ODOBJmax | 30.00 | mm | ODEYEmin | 16.82 | mm | fcomb1 | 2665.5 mm |
| TΘ | 1.51 | degrees | LΘ | 0.6 | degrees | | |

| | | | |
|---|---|---|---|
| ODOBJmax/ODEYEmin | 1.78 | \|f3/f4\| | 0.74 |
| f7/f8 | 1 | f3/f4 | −0.74 |

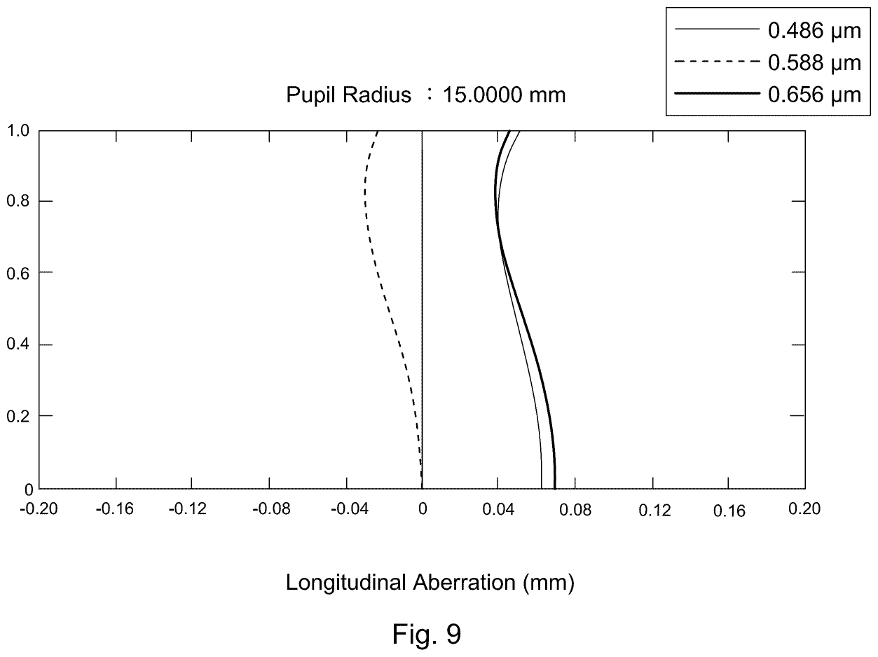

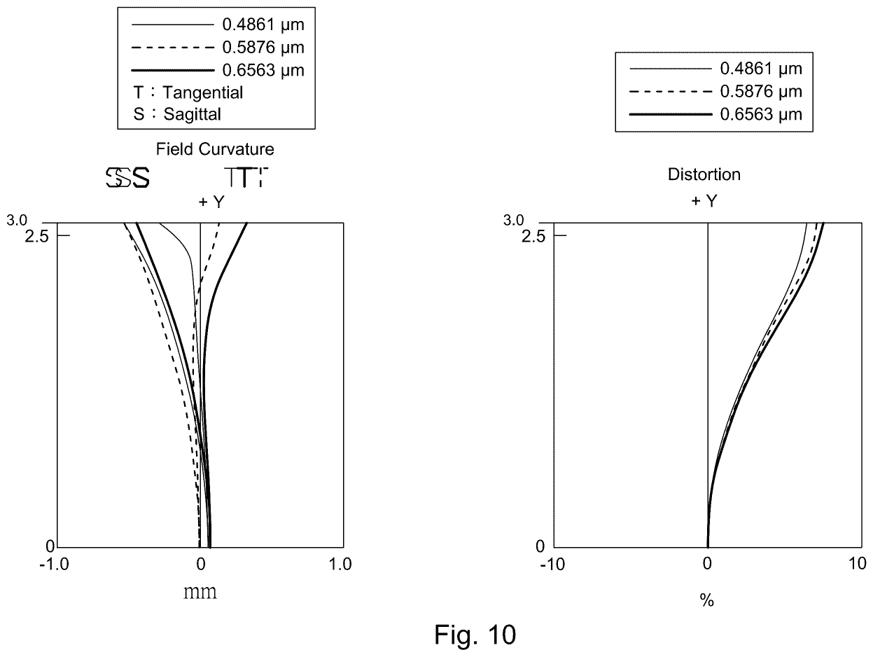

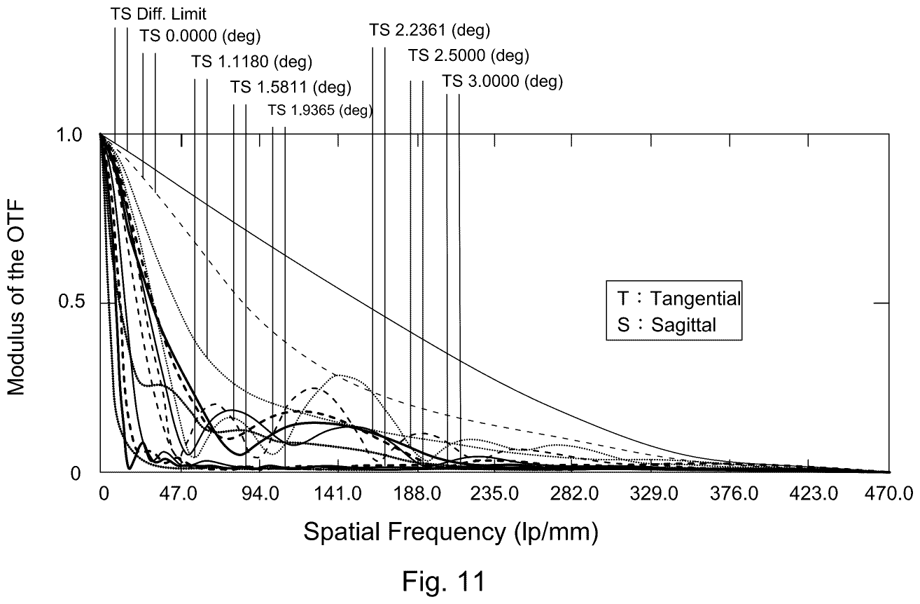

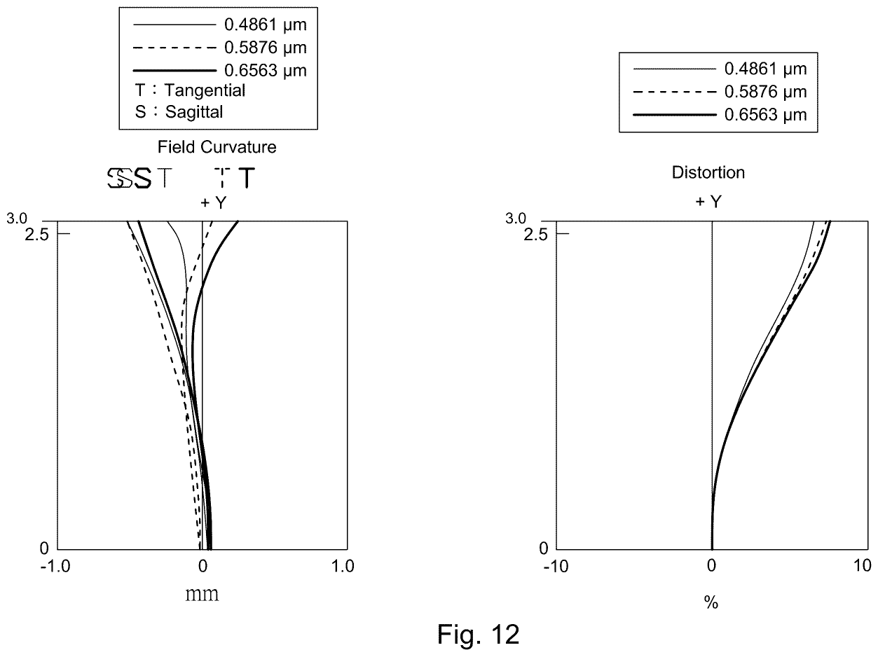

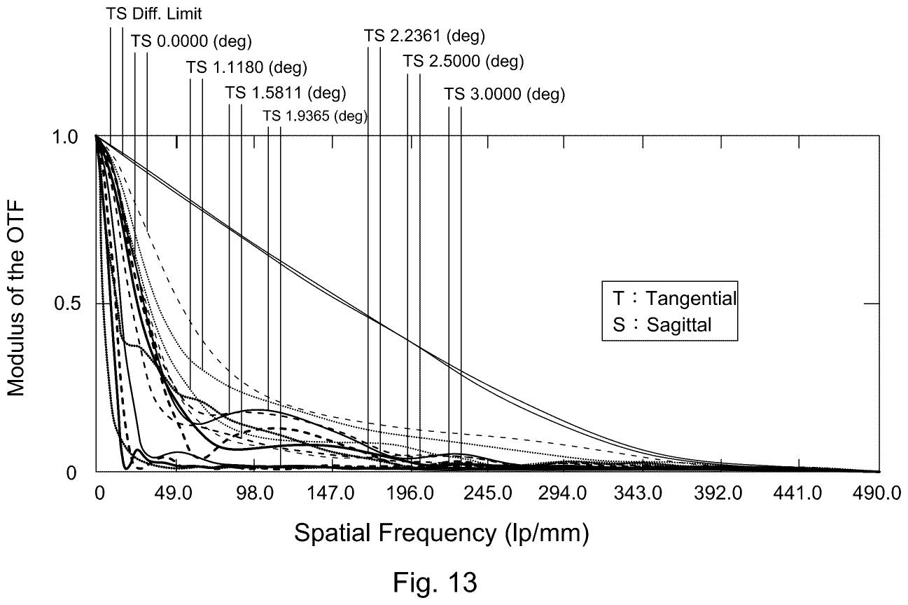

In addition, the optical system 2 of the second embodiment can meet the requirements of optical performance as seen in FIGS. 9-13. It can be seen from FIG. 9 that the longitudinal aberration in the optical system 2 of the second embodiment without shake ranges from −0.04 mm to 0.08 mm. It can be seen from FIG. 10 that the field curvature of tangential direction and sagittal direction and distortion in the optical system 2 of the second embodiment without shake range from −0.6 mm to 0.3 mm and 0% to 8.0%, respectively. It can be seen from FIG. 11 that the modulation transfer function of tangential direction and sagittal direction in the optical system 2 of the second embodiment without shake ranges from 0.0 to 1.0. It can be seen from FIG. 12 that the field curvature of tangential direction and sagittal direction and distortion in the optical system 2 of the second embodiment under maximum shake compensation range from −0.6 mm to 0.3 mm and 0% to 8.0%, respectively. It can be seen from FIG. 13 that the modulation transfer function of tangential direction and sagittal direction in the optical system 2 of the second embodiment under maximum 435 shake compensation ranges from 0.0 to 1.0. It is obvious that the longitudinal aberration, the field curvature, and the distortion of the optical system 2 of the second embodiment can be corrected effectively and the image resolution can meet the requirements. Therefore, the optical system 2 of the second embodiment is capable of good optical performance.

The present invention also provides a third embodiment of an optical system. The lenses and optical element configuration of the optical system 3 of the third embodiment is similar to that of the optical system 2 of the second embodiment (see FIG. 8). However, some lens surface shapes of the optical system 3 differ from those of the optical system 2. These differences are that the object side surface S33 of the second lens L32 of the optical system 3 is a convex surface, the object side surface S34 of the third lens L33 is a plane surface and the image side surface S35 is a concave surface, and the object side surface S311 of the fourth lens L34 is a convex surface and the image side surface S312 is a plane surface.

Table 5 shows the optical specification of the optical system 3.

TABLE 5

| | | | | | Effective | Effective | |
|---|---|---|---|---|---|---|---|
| | Radius of | | | | Focal | Optical | |
| Surface | Curvature | Thickness | | | Length | Diameter | |
| Number | (mm) | (mm) | Nd | Vd | (mm) | (mm) | Remark |
| S31 | 71.96 | 6.32 | 1.618 | 63.406 | 62.6 | 30.00 | L31 |
| S32 | −80.87 | 1.06 | 1.911 | 35.25 | −140.8 | 30.00 | L32 |
| S33 | −220.29 | 24.56 | | | | 30.00 | |
| S34 | ∞ | 2.58 | 1.569 | 56.041 | −82.27 | 24.29 | L33 |
| S35 | 46.8 | 2 | | | | 23.74 | |
| S36 | ∞ | 2.2 | 1.5168 | 64.199 | | 30.00 | OE3 |
| S37 | ∞ | 0.05 | 1.41 | 49.9 | | 30.00 | |
| S38 | ∞ | 0.85 | 1.4498 | 55.51 | | 30.00 | |
| S39 | ∞ | 0.5 | 1.5168 | 64.199 | | 30.00 | |
| S310 | ∞ | 1.54 | | | | 30.00 | |
| S311 | 55.76 | 2.73 | 1.523 | 58.658 | 106.6 | 24.25 | L34 |
| S312 | ∞ | 32.1 | | | | 24.11 | |
| S313 | ∞ | 51.0 | 1.5688 | 56.06 | | 20.2 | P31 |
| S314 | ∞ | 0.8 | — | — | | 15.2 | |
| S315 | ∞ | 51.82 | 1.5688 | 56.06 | | 15.2 | P32 |
| S316 | ∞ | 2.5855 | | | | 20 | |
| S317 | ∞ | 6.0252 | | | | 14.94 | |
| S318 | −16.7 | 1.5 | 1.847 | 23.787 | −10.22 | 16.2 | L35 |
| S319 | 18.7 | 8.33 | 1.804 | 46.574 | 12.91 | 20.6 | L36 |
| S320 | −18.7 | 0.3 | | | | 21.9 | |
| S321 | 32.97 | 5.13 | 1.569 | 56.041 | 39.6 | 23.51 | L37 |
| S322 | −67.08 | 0.3 | | | | 23.29 | |
| S323 | 32.97 | 5.13 | 1.569 | 56.041 | 39.6 | 22.03 | L38 |
| S324 | −67.08 | 17.62 | | | | 20.8 | |

Table 6 shows the parameters and condition values for conditions (1)-(5) in accordance with the optical system 3 of the third embodiment. It can be seen from Table 6 that the optical system 3 of the third embodiment satisfies the conditions (1)-(5).

TABLE 6

| | | | | | | | |
|---|---|---|---|---|---|---|---|
| ODOBJmax | 30.00 | mm | ODEYEmin | 16.2 | mm | fcomb1 | 4001.2 mm |
| TΘ | 1.51 | degrees | LΘ | 0.6 | degrees | | |

| | | | |
|---|---|---|---|
| ODOBJmax/ODEYEmin | 1.85 | \|f3/f4\| | 0.77 |
| f7/f8 | 1 | f3/f4 | −0.77 |

The optical system of embodiments 1 to 3 can achieve optical image stabilization by adjusting the image side surface of the liquid prism tilting with the direction which is perpendicular to the optical axis, but not limited thereto. The optical systems of embodiments 1 to 3 can also perform optical image stabilization by adjusting the object side surface or image side surface of the liquid prism tilting with the direction which is perpendicular to the optical axis. No sound is produced when the optical image stabilization method is activated. When the optical image stabilization method is turned off, the object side surface or image side surface which originally tilt with the direction which is perpendicular to the optical axis will be restored to the direction which is not perpendicular to the optical axis, so as to maintain the original image quality. In addition, even if the optical system suddenly loses power, it will not affect the operation of other functions.

In other embodiments, the optical elements of the above embodiments 1 to 3 may be replaced with prism instead of liquid prism, such as, but not limited to triangular prism or quadrilateral prism. When the optical image stabilization is activated, a slope of the prism acts as a light guide surface. When the prism rotates, moves, or tilts relative to the optical axis, the light guide surface also rotates, moves, or tilts relative to the optical axis, making the light guide surface have an inclination angle with the perpendicular direction of the optical axis. The focal length of the object lens group remains unchanged after the prism is moved.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical system comprising:
an object lens group;
an erector lens group; and
an eyepiece group;
wherein the object lens group, the erector lens group, and the eyepiece group are arranged in order from an object side to an image side along an optical axis;
wherein the object lens group comprises a first lens, a second lens, a third lens, a fourth lens, and an optical element;
wherein the optical element is disposed between the second lens and the third lens or the optical element is disposed between the third lens and the fourth lens;
wherein the optical element comprises a light guide surface and the light guide surface is rotated, moved, or tilted relative to the optical axis;
wherein the first lens is with refractive power and comprises a convex surface facing the object side;
wherein the second lens is with refractive power;
wherein the third lens is with refractive power;
wherein the fourth lens is with refractive power;
wherein the first lens, the second lens, the third lens, and the fourth lens are arranged in order from the object side to the image side along the optical axis;
wherein the eyepiece group comprises a fifth lens, a sixth lens, a seventh lens, and an eighth lens;
wherein the fifth lens is with refractive power and comprises a concave surface facing the object side;
wherein the sixth lens is with refractive power and comprises a convex surface facing the image side;
wherein the seventh lens is with positive refractive power and comprises a convex surface facing the object side;
wherein the eighth lens is with positive refractive power and comprises a convex surface facing the object side;
wherein the fifth lens, the sixth lens, the seventh lens, and the eighth lens are arranged in order from the object side to the image side along the optical axis.

2. The optical system as claimed in claim 1, wherein:
the first lens is a biconvex lens and further comprises another convex surface facing the image side;
the second lens is a meniscus lens with negative refractive power and comprises a concave surface facing the object side and a convex surface facing the image side;
the third lens is a meniscus lens with positive refractive power and comprises a convex surface facing the object side and a concave surface facing the image side;
the fourth lens is a meniscus lens with negative refractive power and comprises a convex surface facing the object side and a concave surface facing the image side;
the fifth lens is a biconcave lens with negative refractive power and further comprises another concave surface facing the image side;
the sixth lens is a biconvex lens and further comprises another convex surface facing the object side;
the seventh lens is a meniscus lens and further comprises a concave surface facing the image side; and
the eighth lens is a meniscus lens and further comprises a concave surface facing the image side.

3. The optical system as claimed in claim 2, wherein the optical system satisfies at least one of following conditions:
$$1.7 \leq ODOBJ max / ODEYE min \leq 2.1 ;$$
$$0.7 \leq \vert f 3 / f 4 \vert \leq 1.8 ;$$
$$( f 3 / f 4 ) < ( f 7 / f 8 ) ;$$
$$fcomb 1 \geq 250 mm ;$$
$$0 degree \leq T Θ \leq 2 degree ;$$
$$0.5 degree \leq L Θ \leq 0.7 degree ;$$
wherein ODOBJmax is a maximum effective optical diameter of the object lens group, ODEYEmin is a minimum effective optical diameter of the eyepiece group, f3 is an effective focal length of the third lens, f4 is an effective focal length of the fourth lens, f7 is an effective focal length of the seventh lens, f8 is an effective focal length of the eighth lens, fcomb1 is an effective focal length of a combination of lenses which are between the object side and the optical element, TΘ is an inclination angle between the light guide surface of the optical element and the vertical direction of the optical axis, and LΘ is a maximum optical compensation angle of the optical system.

4. The optical system as claimed in claim 2, wherein:
the optical element is a liquid prism;
the liquid prism comprises an object side surface facing the object side and an image side surface facing the image side, and both of the object side surface and image side surface are plane surfaces; and
when the object side surface is perpendicular to the optical axis, the image side surface is tilted at an inclination angle to the vertical direction of the optical axis to achieve optical image stabilization, or when the image side surface is perpendicular to the optical axis, the object side surface is tilted at an inclination angle to the vertical direction of the optical axis to achieve optical image stabilization.

5. The optical system as claimed in claim 1, wherein:
a combination of the first lens and the second lens is with positive refractive power and a combination of the fifth lens and the sixth lens is with positive refractive power;
the first lens is a biconvex lens with positive refractive power and further comprises another convex surface facing the image side;
the second lens is with negative refractive power and comprises a concave surface facing the object side;
the fifth lens is a biconcave lens with negative refractive power and further comprises another concave surface facing the image side; and
the sixth lens is a biconvex lens with positive refractive power and further comprises another convex surface facing the object side.

6. The optical system as claimed in claim 5, wherein the second lens is a biconcave lens and further comprises another concave surface facing the image side.

7. The optical system as claimed in claim 5, wherein the second lens is a meniscus lens and further comprises a convex surface facing the image side.

8. The optical system as claimed in claim 1, wherein the optical system satisfies at least one of following conditions:
$$1.7 \leq ODOBJ max / ODEYE min \leq 2.1 ;$$
$$0.7 \leq \vert f 3 / f 4 \vert \leq 1.8 ;$$
$$( f 3 / f 4 ) < ( f 7 / f 8 ) ;$$
$$fcomb 1 \geq 250 mm ;$$
$$0 degree \leq T Θ \leq 2 degree ;$$
$$0.5 degree \leq L Θ \leq 0.7 degree ;$$
wherein ODOBJmax is a maximum effective optical diameter of the object lens group, ODEYEmin is a minimum effective optical diameter of the eyepiece group, f3 is an effective focal length of the third lens, f4 is an effective focal length of the fourth lens, f7 is an effective focal length of the seventh lens, f8 is an effective focal length of the eighth lens, fcomb1 is an effective focal length of a combination of lenses which are between the object side and the optical element, TΘ is an inclination angle between the light guide surface of the optical element and the vertical direction of the optical axis, and LΘ is a maximum optical compensation angle of the optical system.

9. The optical system as claimed in claim 1, wherein:
the optical element is a liquid prism;
the liquid prism comprises an object side surface facing the object side and an image side surface facing the image side, and both of the object side surface and image side surface are plane surfaces; and
when the object side surface is perpendicular to the optical axis, the image side surface is tilted at an inclination angle to the vertical direction of the optical axis to achieve optical image stabilization, or when the image side surface is perpendicular to the optical axis, the object side surface is tilted at an inclination angle to the vertical direction of the optical axis to achieve optical image stabilization.

10. An optical system comprising:
an object lens group;
an erector lens group; and
an eyepiece group;
wherein the object lens group, the erector lens group, and the eyepiece group are arranged in order from an object side to an image side along an optical axis;
wherein the object lens group comprises a first lens, a second lens, a third lens, a fourth lens, and an optical element;
wherein the optical element is disposed between the second lens and the third lens or the optical element is disposed between the third lens and the fourth lens;
wherein the first lens is with refractive power and comprises a convex surface facing the object side;
wherein the second lens is with refractive power;
wherein the third lens is with refractive power;
wherein the fourth lens is with refractive power;
wherein the refractive power of the fourth lens is opposite to the refractive power of the third lens;
wherein the first lens, the second lens, the third lens, and the fourth lens are arranged in order from the object side to the image side along the optical axis;
wherein the eyepiece group comprises a fifth lens, a sixth lens, a seventh lens, and an eighth lens;
wherein the fifth lens is with refractive power and comprises a concave surface facing the object side;
wherein the sixth lens is with refractive power and comprises a convex surface facing the image side;
wherein the seventh lens is a biconvex lens with positive refractive power and comprises a convex surface facing the object side and another convex surface facing the image side;
wherein the eighth lens is a biconvex lens with positive refractive power and comprises a convex surface facing the object side and another convex surface facing the image side;
wherein the fifth lens, the sixth lens, the seventh lens, and the eighth lens are arranged in order from the object side to the image side along the optical axis.

11. The optical system as claimed in claim 10, wherein the optical element comprises a light guide surface and the light guide surface is rotated, moved, or tilted relative to the optical axis.

12. The optical system as claimed in claim 11, wherein:
a combination of the first lens and the second lens is with positive refractive power and a combination of the fifth lens and the sixth lens is with positive refractive power;
the first lens is a biconvex lens with positive refractive power and further comprises another convex surface facing the image side;
the second lens is with negative refractive power and comprises a concave surface facing the object side;
the fifth lens is a biconcave lens with negative refractive power and further comprises another concave surface facing the image side; and
the sixth lens is a biconvex lens with positive refractive power and further comprises another convex surface facing the object side.

13. The optical system as claimed in claim 12, wherein the second lens is a biconcave lens and further comprises another concave surface facing the image side.

14. The optical system as claimed in claim 12, wherein the second lens is a meniscus lens and further comprises a convex surface facing the image side.

15. The optical system as claimed in claim 10, wherein:
the third lens is with negative refractive power and comprises a plane surface facing the object side or the image side;
the fourth lens is with positive refractive power and comprises a plane surface facing the object side or the image side; and
when the third lens comprises a concave surface facing the object side, the fourth lens comprises a convex surface facing the image side, or when the third lens comprises a concave surface facing the image side, the fourth lens comprises a convex surface facing the object side.

16. The optical system as claimed in claim 15, wherein:
a combination of the first lens and the second lens is with positive refractive power and a combination of the fifth lens and the sixth lens is with positive refractive power;
the first lens is a biconvex lens with positive refractive power and further comprises another convex surface facing the image side;
the second lens is with negative refractive power and comprises a concave surface facing the object side;
the fifth lens is a biconcave lens with negative refractive power and further comprises another concave surface facing the image side; and
the sixth lens is a biconvex lens with positive refractive power and further comprises another convex surface facing the object side.

17. The optical system as claimed in claim 16, wherein the second lens is a biconcave lens and further comprises another concave surface facing the image side.

18. The optical system as claimed in claim 16, wherein the second lens is a meniscus lens and further comprises a convex surface facing the image side.

19. The optical system as claimed in claim 10, wherein the optical element further comprises a light guide surface and the optical system satisfies at least one of following conditions:
$$1.7 \leq ODOBJ max / ODEYE min \leq 2.1 ;$$
$$0.7 \leq \vert f 3 / f 4 \vert \leq 1.8 ;$$
$$( f 3 / f 4 ) < ( f 7 / f 8 ) ;$$
$$fcomb 1 \geq 250 mm ;$$
$$0 degree \leq T Θ \leq 2 degree ;$$
$$0.5 degree \leq L Θ \leq 0.7 degree ;$$
wherein ODOBJmax is a maximum effective optical diameter of the object lens group, ODEYEmin is a minimum effective optical diameter of the eyepiece group, f3 is an effective focal length of the third lens, f4 is an effective focal length of the fourth lens, f7 is an effective focal length of the seventh lens, f8 is an effective focal length of the eighth lens, fcomb1 is an effective focal length of a combination of lenses which are between the object side and the optical element, TΘ is an inclination angle between the light guide surface of the optical element and the vertical direction of the optical axis, and LΘ is a maximum optical compensation angle of the optical system.

20. The optical system as claimed in claim 10, wherein:
the optical element is a liquid prism;
the liquid prism comprises an object side surface facing the object side and an image side surface facing the image side, and both of the object side surface and image side surface are plane surfaces; and
when the object side surface is perpendicular to the optical axis, the image side surface is tilted at an inclination angle to the vertical direction of the optical axis to achieve optical image stabilization, or when the image side surface is perpendicular to the optical axis, the object side surface is tilted at an inclination angle to the vertical direction of the optical axis to achieve optical image stabilization.
